(19) United States
(12) Patent Application Publication
(10) Pub. No.: US 2012/0290149 A1
(43) Pub. Date: Nov. 15, 2012

(54) Methods and Apparatus for Selective Power Enablement with Predictive Capability

(75) Inventors: Johannes Geir Kristinsson, Ann Arbor, MI (US); Ryan Abraham McGee, Ann Arbor, MI (US); Fazal Urrahman Syed, Canton, MI (US)

(73) Assignee: FORD GLOBAL TECHNOLOGIES, LLC, Dearborn, MI (US)

(21) Appl. No.: 13/103,448

(22) Filed: May 9, 2011

(51) Int. Cl. B60W 20/00; B60W 10/08; B60W 10/06

(52) U.S. Cl. 701/2; 701/22; 903/903

(57) ABSTRACT

A computer implemented method includes examining a travel route to determine the presence of emission control zones along the route. The method further includes determining how much power will be required to operate a vehicle along the portions of the route within the emission control zones. Also, this method includes preserving the determined amount of power required to operate the vehicle along the portions of the route within the emission control zones. Further, the method includes selectively activating a vehicle electric power mode using the preserved power while the vehicle is operating within the emission control zones.

### TECHNICAL FIELD

The illustrative embodiments generally relate to methods and apparatus for selective power enablement with predictive capability.

### BACKGROUND

Traditional gasoline vehicles only have one mode of operation, the energy used to propel the vehicle stems from burning fossil fuel in an internal combustion engine. With the introduction of hybrid electric vehicles (HEVs), it became possible to harvest some of the energy losses of conventional gasoline vehicles, such as braking, and store that energy in an on-board battery. This energy could then be used to power the vehicle in conjunction with or in replacement of gasoline generated power. Typically, however, the somewhat restricted availability of capturable energy and the limited capacity of the on-board battery don't allow for extensive electrical propulsion.

Plug-in HEVs (PHEVs), however, often have much larger batteries and those batteries can be charged from the grid. These vehicles often come equipped with more powerful electric machinery as well, and it can be possible to drive them for long distances on electric power alone.

In many common applications, a PHEV will be in electric mode at low speeds and for the first part of the trip (e.g., until there is no more energy remaining). Typically, such an operation paradigm permits the user to ensure maximum electrical energy usage and minimal gasoline usage. Many hybrid users prefer to use the electric energy as much as possible, and this standard mode of operation provides such an experience.

While HEVs and PHEVs are becoming more prevalent, major cities are also getting more and more crowded with vehicles. When these are gasoline powered vehicles, this can lead to a deterioration in air quality in the city. To respond to this, London, for example, has introduced a “Congestion Charge Zone.” The city imposes a premium fee on drivers that drive within this charge zone. Currently, PHEV owners and other “green” vehicle drivers enjoy a discount on the charge, while gasoline drivers pay full fare. It is anticipated, however, that in the future these zones, or zones like these zones, will be designated as electric power only. In such a case, vehicles incapable of operating in these zones under electric power while in the zone may be denied entry entirely. PHEVs and other vehicles having both electric and gasoline modes, may be expected to operate under electric mode only while in these zones, or at least pay a premium if they do not.

### SUMMARY

In a first illustrative embodiment, a computer implemented method includes examining a travel route to determine the presence of emission control zones along the route. The illustrative method further includes determining how much power will be required to operate a vehicle along the portions of the route within the emission control zones.

Also, this illustrative method includes preserving the determined amount of power required to operate the vehicle along the portions of the route within the emission control zones. Further, the method includes selectively activating a vehicle electric power mode using the preserved power while the vehicle is operating within the emission control zones.

In a second illustrative embodiment, a system includes a vehicle computing system operable to communicate with at least a remote server to obtain cloud based computing services and a remote system operable to receive information from and send information to the vehicle computing system. In this embodiment, the vehicle computing system is operable to determine a vehicle's geographic location. The vehicle computing system is further operable to compare the vehicle's geographic location to a list of emission control areas and determine if the vehicle's geographic location is within an emission control area. Also, the vehicle computing system is operable to instruct usage of an electricity power mode if the vehicle's geographic location is within an emission control area. Finally, the vehicle computing system is further operable to act to preserve sufficient power to allow a vehicle to operate in the electricity power mode during travel in all emission control areas along a known route.

In a third illustrative embodiment, a computer readable storage medium stores instructions that, when executed, cause a vehicle computing system to perform the method including examining a travel route to determine the presence of emission control zones along the route. The method additionally includes determining how much power will be required to operate a vehicle along the portions of the route within the emission control zones and preserving the determined amount of power required to operate the vehicle along the portions of the route within the emission control zones. The method further includes selectively activating a vehicle electric power mode using the preserved power while the vehicle is operating within the emission control zones.

### BRIEF DESCRIPTION OF THE DRAWINGS

FIG. 1 shows an illustrative example of a vehicle computing system;

FIG. 2 shows an illustrative example of a green zone driving system;

FIG. 3 shows an illustrative example of a process for implementing green zone power management strategies over a route;

FIG. 4 shows an illustrative example of a process for obtaining route information when the user has not input a particular route;

FIG. 5 shows one illustrative example of a prediction process; and

FIG. 6 shows an illustrative example of a power requirement calculation.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

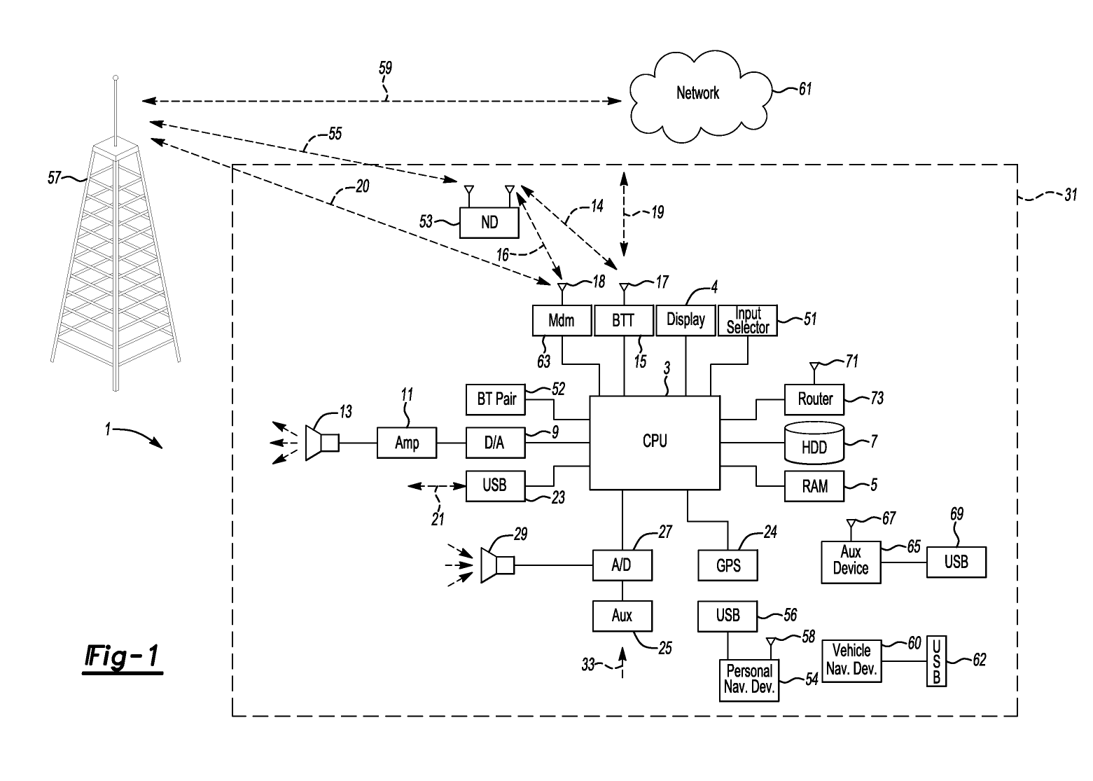

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users.

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

A vehicle may be equipped with a green zone driving system as described with respect to various of the illustrative embodiments. While the embodiments disclosed herein are provided to show non-limiting examples, they are intended for illustrative purposes, and do not limit the scope of the invention thereto.

The driving system may encompass a database or other data warehouse of green zone definitions. These green zones can correlate to government designated zones, or a user can choose to designate zones of his own. For example, the user could elect not to run on gasoline when in his neighborhood or when near a park. It could even be possible to simply store an instruction as a user preference, such as, but not limited to “when within two blocks of a park, use electric power until no longer within that proximity.” Such preferences could allow for dynamic green zones based on the user instructions. A database of parks (assuming the data is not included with the map data) could be cross referenced with a given route to determine “dynamic” zones along the route, once a route was known. Once encountered, the zone could be added to the database as a defined zone, or, if the computing cost of lookup is low, the data could be dynamically accessed each time.

Driver preferred zones can be set, for example, using a vehicle human machine interface (HMI) or online and then uploaded to the database (which may be located on a server in the cloud or on the vehicle's computing system).

In these illustrative examples, the system will monitor the position of the vehicle and determine if the vehicle is within a green zone. If the vehicle enters (or starts a trip inside of) a green zone, the system may instruct the use of electric power if possible.

In at least one illustrative example, the system monitors and is aware of both the capabilities of the vehicle (received, for example, without limitation, from a battery management system) and the current route (received, for example, without limitation, from a navigation system). Accordingly, the system has the capability of determining how much power is needed for the planned green zone driving, and a reasonable chance of the vehicle being able to complete all green zone driving with the current power charge. If the vehicle is projected not to be able to complete the trip, the system can warn the driver.

In at least one embodiment, the system can analyze a route, determine how much power is required to complete all the green zone driving on the route, and even recommend or implement a power management strategy to conserve or even accrue power so that all green zone driving can be completed using electric power.

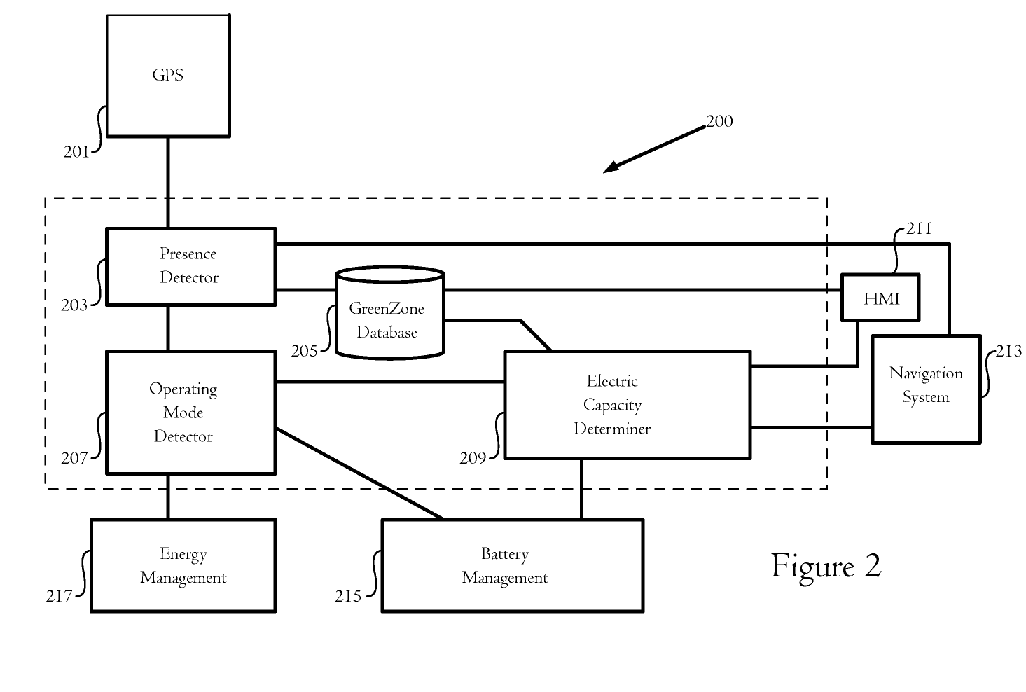

FIG. 2 shows an illustrative example of a green zone driving system. In this embodiment, a global positioning system (GPS) 201 provides information relating to the vehicle's current location. The GPS, in this embodiment can provide the data to a presence detector 203. The presence detector uses the GPS information to determine the present geographic location of the vehicle.

Information obtained and/or determined by the presence detector can be compared to data from a Navigation System 213 to determine where, on a current route, the vehicle lies. Since the route, in this example, is known, knowing the vehicle's current location provides the capacity to know where the vehicle is on the route.

Information from the presence detector also can be compared to information from a green zone database 205. This will allow the system to determine if the vehicle is presently within a green zone. If the vehicle is within a green zone, the presence detector can notify the operating mode decider 207. The operating mode decider can then elect to put the vehicle into an electric mode (with or without informing the driver, depending on system configuration).

The operating mode decider may also communicate with an energy management system 217 to instruct a particular mode of operation. Additionally, in this example, the operating mode decider may communicate with a battery management module 215 so that the decider is aware of current battery capacity. If the battery is empty or low, the system will have to determine if switching to electric power is appropriate.

While in a green zone, for example, and running on electric power, an electric capacity determiner 209 may have to determine if there is a risk of the vehicle not being able to exit the green zone before running out of stored electric energy. It can use data from at least the navigation system, the database and the battery management module to aid in this determination. If the possibility of running out of electric power exists, the operating mode manager may be notified.

Additionally or alternatively, the driver may be notified of a low power state (by, for example, without limitation, the electric capacity determiner). The driver may be notified via the HMI 211, and the system may re-route the vehicle to help get it out of the green zone before the power runs out.

Also, in this embodiment, a system such as the electric capacity determiner may be able to instruct or suggest operation of the vehicle in a power preservation state, which may help preserve enough power to get the driver clear of the green zone while still running on electricity. This state may include, but is not limited to, limiting use of HVAC systems and radio, limited acceleration and speed capabilities, etc. Any techniques that preserve power for use in moving the vehicle may be employed.

In at least one embodiment, a vehicle may be equipped with a communication capability that allows it to access at least one remote information source. This information source (such as a remote server or the Internet) may be used to provide updated data on mandated or recommended green zones. It may even be possible for a user to “subscribe” to a website that provides advisable green zone locations (e.g., without limitation, schools, parks, neighborhoods, etc.).

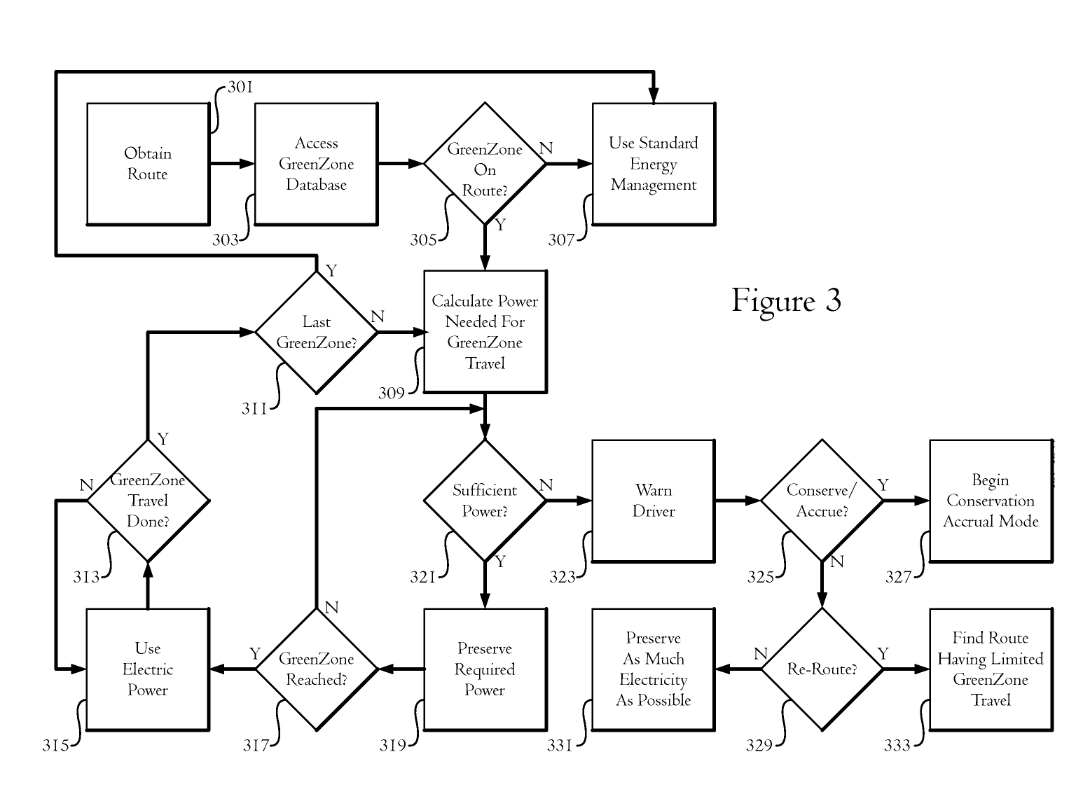

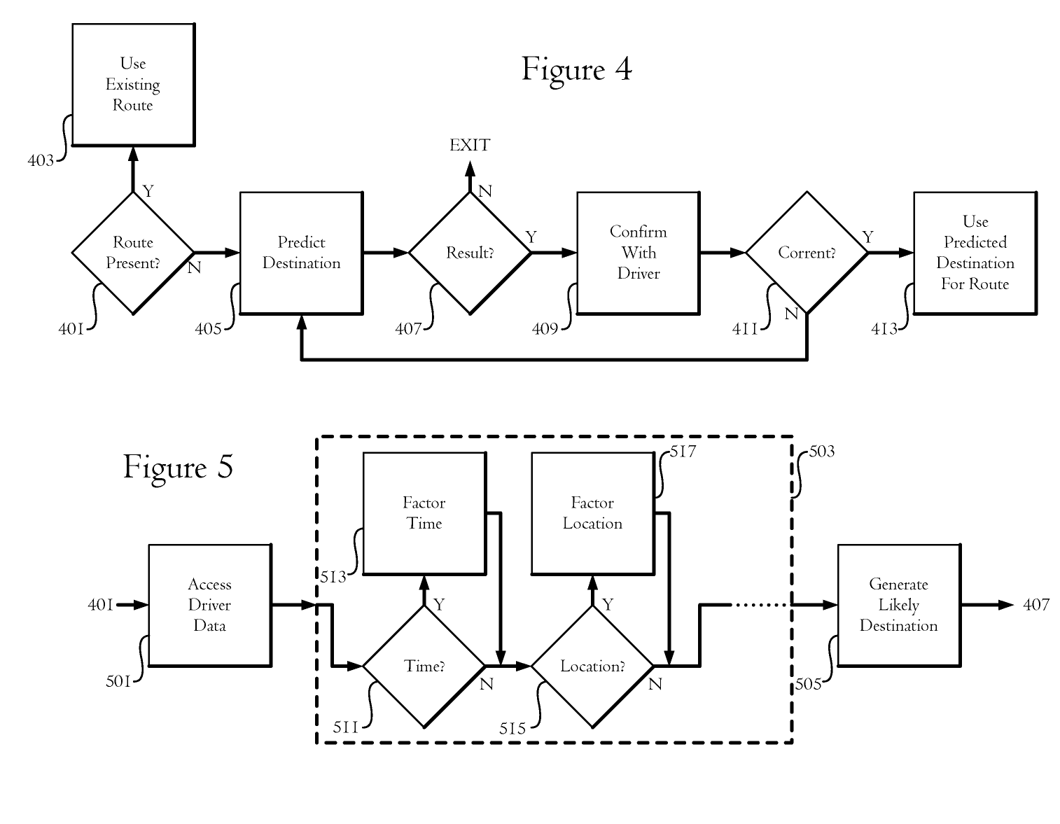

FIG. 3 shows an illustrative example of a process for implementing green zone power management strategies over a route. In this illustrative embodiment, the process first obtains a route 301. In one example the route is user input, but in another example, the route may be predictively determined. Predictive route determination is discussed in more detail with respect to FIGS. 4 and 5.

Next, the process accesses a green zone database or other data store 303. This will allow the process to utilize government or user-defined green zones when managing power. If there are no green zones along the present route 305, the process can use a standard power management strategy and continue along.

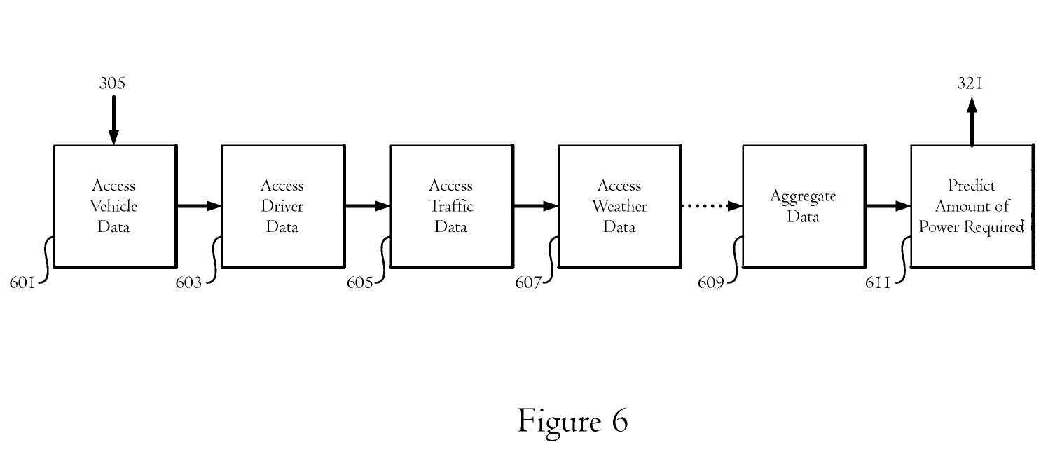

If there are green zones along a route, the process can estimate the power required to travel in the green zones. This process is described in more detail with respect to FIG. 6. If the vehicle has sufficient power to travel in all the green zones along a route 321, then the needed amount of power may be preserved 319 until a green zone is reached 317.

Once the green zone is reached, power management can engage an electric power system 315. This power can be used until the green zone travel is completed 313. If the green zone just completed was the last green zone on a trip 311, the system can return to a conventional power management strategy. If additional green zones remain, the process can check to see if there is sufficient power remaining to travel in the remaining green zones 309, 321.

If there is ever insufficient power to travel in a green zone 321, the process can warn the driver 323, and possibly suggest a new route. If there exists the capacity to store or preserve enough power between a present location and a green zone, such that travel is possible 325, the system may enter a conservation/power accrual mode 327.

If there will be insufficient power, the system may ask if the driver would like to select a new route 329. If the driver does not want a new route, the system may act to preserve as much power as possible, or as the driver will allow it to. If the driver desires a new route, the system may find the shortest route that only travels in green zones for an amount of possible electric drive time 333.

This is just one example of a process for power management, but it shows that a system can predictively determine a power requirement for travel along portions of a trip, and then implement a strategy to attempt to ensure that sufficient power remains for travel using that power then the portion of the trip for which power is preserved is reached.

FIG. 4 shows an illustrative example of a process for obtaining route information when the user has not input a particular route. In this illustrative example, a predictive process is used. The predictive process considers one or more factors relating to a current state of the user (e.g., without limitation, time of day, present location, etc.). Based at least in part on information congruencies relating to the considered factors, the system may attempt to predict or guess where the user intends to travel.

First, the process checks to see if a route has been user-input 401. If the user has input a route, no prediction is necessary, so the process can simply use the input route 403.

If there is no input route, however, the process may attempt to predict a route 405. Since the process may not actually know definitively where the user is headed, provided that the prediction attempt gives a result 407, the process may confirm a predicted destination 409. If the user concurs 411, the process can use a route to the predicted destination as a route to be traveled 413. If the user does not concur, the process can try predicting again, eliminating the first prediction from the set of possible destinations.

In at least one illustrative example, data recorders may log usage of a vehicle. While logging usage, they may also record times, weather data, other environmental data, dates of travel, etc. When sufficient data on a particular vehicle is gathered, predictive routing may be implemented. FIG. 5 shows one illustrative example of a prediction process.

In the example shown in FIG. 5, one or more pieces of driver data stored in a database are accessed 501. As noted, this data may have been gathered over the time, and stored with respect to a vehicle or even a particular driver.

Element 503 of FIG. 5 shows some illustrative non-limiting examples of factors that may be considered in determining a likely route. In this example, the process checks to see if a current time is known 511, if so, the process will factor time into the prediction 513, by, for example, determining where the driver or vehicle usually travels at the known time. Also, in this example, the process checks to see if a vehicle location is known 515. If the location is known, the process may consider location in a prediction 517. For example, if it is 6 AM and the location is the user's house, and it is a weekday, there is a reasonable chance the vehicle may be going to work, school, etc. Other factors not shown may also be considered.

In one example of other factors, it is common that people do not always go to the same locations on, for example, weekends. But, if someone commonly heads to the movies on Sunday whenever it is raining, then entering the vehicle on a Sunday afternoon while it is raining may cause a prediction that the vehicle is headed to the movies. By considering a variety of geographic, temporal and/or environmental factors, suitable predictions of destinations can be made 505. Also, this allows a user to utilize systems such as the present invention's capabilities without requiring the user to input a destination every time a vehicle is used.

FIG. 6 shows an illustrative example of a power requirement calculation. In this illustrative example, a process has determined a route has one or more green zones thereon 305. Then, the process accesses one or more data sets to determine likely power usage.

In this example, the process accesses a vehicle data set 601. Vehicle data may include, but is not limited to MPGe (a standard for measuring electric power efficiency), tire pressure, battery charge, regenerative systems, map data, expanded map data (curvature, inclinations, altitude, etc.), etc. The process can use this data to calculate a baseline for likely power consumption, as well as factor in any vehicle anomalies that may increase power consumption.

Also, driver data may be considered 603. The vehicle may have, over time, stored data relating to how a particular driver operates a vehicle. If the driver is known, the vehicle can determine how much power a particular driver may used based on past driving observations.

Traffic data (such as that from a remote, real time source) may also be considered 605. Since congestion can cause extended travel time and power usage, it may be useful to know current traffic patterns in upcoming green zones.

Weather data may additionally be considered. In some cases, electric cars are less efficient at certain temperatures, and it may be useful to know if the temperature in a green zone will cause accelerated power consumption or loss of efficiency. Once all suitable data has been considered, the results can be aggregated and a prediction of power consumption for travel can be obtained.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
examining a travel route to determine the presence of emission control zones along the route;
determining how much power will be required to operate a vehicle along the portions of the route within the emission control zones;
preserving the determined amount of power required to operate the vehicle along the portions of the route within the emission control zones; and
selectively activating a vehicle electric power mode using the preserved power while the vehicle is operating within the emission control zones.

2. The method of claim 1, wherein the preserving further includes selectively activating a gasoline power mode for at least some portion of vehicle operation outside the emission control zones if sufficient power does not exist in a vehicle power storage to power the vehicle in electric mode over the entire route.

3. The method of claim 1, further including, if the travel route does not exist, predicting a likely travel destination and using a route to the predicted destination for the examining.

4. The method of claim 3, further comprising confirming the predicted destination with a vehicle occupant.

5. The method of claim 3, wherein the predicting further includes predicting based at least in part on an observed vehicle location.

6. The method of claim 3, wherein the predicting further includes predicting based at least in part on an observed time of day.

7. The method of claim 3, wherein the predicting further includes predicting based at least in part on an observed weather condition.

8. The method of claim 3, wherein the predicting further includes predicting based at least in part on an observed day of the week.

9. The method of claim 3, wherein the predicting is calculated remotely from the vehicle by a cloud-based computing system capable of communication with a vehicle computing system.

10. The method of claim 3, wherein the predicting further includes predicting based at least in part on previously observed and stored data relating to the vehicle.

11. The method of claim 3, wherein the predicting further includes predicting based at least in part on previously observed and stored data relating to a driver.

12. The method of claim 1, wherein the emission control zone is a user-defined zone or a government defined zone.

13. A system comprising:
a vehicle computing system operable to communicate with at least a remote server to obtain cloud based computing services;
a remote system operable to receive information from and send information to the vehicle computing system;
wherein the vehicle computing system is operable to determine a vehicle's geographic location,
wherein the vehicle computing system is further operable to compare the vehicle's geographic location to a list of emission control areas and determine if the vehicle's geographic location is within an emission control area,
wherein the vehicle computing system is further operable to instruct usage of an electricity power mode if the vehicle's geographic location is within an emission control area, and
wherein the vehicle computing system is further operable to act to preserve sufficient power to allow a vehicle to operate in the electricity power mode during travel in all emission control areas along a known route.

14. The system of claim 13, wherein the vehicle computing system is operable to communicate with the remote server to receive a predicted destination and/or route if there is no known route.

15. The system of claim 14, wherein the vehicle computing system is operable to relay a current vehicle location to the remote server.

16. The system of claim 14, wherein the vehicle computing system is operable to relay a current weather condition to the remote server.

17. A computer readable storage medium storing instructions that, when executed, cause a vehicle computing system to perform the method comprising:
examining a travel route to determine the presence of emission control zones along the route;
determining how much power will be required to operate a vehicle along the portions of the route within the emission control zones;
preserving the determined amount of power required to operate the vehicle along the portions of the route within the emission control zones; and
selectively activating a vehicle electric power mode using the preserved power while the vehicle is operating within the emission control zones.

18. The storage medium of claim 17, wherein the preserving further includes selectively activating a gasoline power mode for at least some portion of vehicle operation outside the emission control zones if sufficient power does not exist in a vehicle power storage to power the vehicle in electric mode over the entire route.

19. The storage medium of claim 17, wherein the method further includes predicting a likely travel destination and using a route to the predicted destination for the examining, if the travel route does not exist.

20. The storage medium of claim 17, wherein the method further includes confirming the predicted destination with a vehicle occupant.
